(19) United States
(12) Patent Application Publication
(10) Pub. No.: US 2007/0282978 A1
(43) Pub. Date: Dec. 6, 2007

(54) Information processing apparatus and method of controlling the same

(76) Inventors: Kazuya Fukushima, Hamura-shi (JP); Nobuaki Takasu, Akishima-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/807,636

(22) Filed: May 30, 2007

(30) Foreign Application Priority Data
May 31, 2006 (JP) 2006-152757

(51) Int. Cl. G06F 15/16

(52) U.S. Cl. 709/218

(57) ABSTRACT

According to one embodiment, an information processing apparatus, includes a detector which detects an external device capable of making connection via wireless communication, a display unit which displays a screen urging a user to select whether or not the connection with the external device via the wireless communication should be made if the external device capable of making connection via wireless communication is detected by the detector, and a connector which makes the connection with external device via the wireless communication if a request for connection with the external device via the wireless communication is made after the screen is displayed on the display unit.

### CROSS-REFERENCE TO RELATED APPLICATIONS

This application is based upon and claims the benefit of priority from Japanese Patent Application No. 2006-152757, filed May 31, 2006, the entire contents of which are incorporated herein by reference.

### BACKGROUND

1. Field

One embodiment of the invention relates to the present invention relates to wireless connection of a computer, etc. and, more particularly, to an information processing apparatus capable of preventing an unexpected and unnecessary connection and a method of controlling the apparatus.

2. Description of the Related Art

In general, to use peripheral devices having different ports, the ports corresponding to the respective peripheral devices are required. In accordance with downsizing of a notebook-type computer, however, maintaining space to provide the ports for connection to the peripheral devices becomes difficult.

To use a plurality of peripheral devices, expansion devices need to be connected to an electronic device body. As a wireless connection between the electronic device and expansion devices, for example, an invention disclosed in JP-A No. 2000-194444 (KOKAI) is known. According to the other invention, when the computer detects an expansion device over wireless communication, wireless connection is automatically executed.

According to the above techniques, however, when an expansion device is detected, wireless connection is automatically executed even if the connection is not desired. If the computer is connected to the expansion device, for example, input means such as a keyboard and speech input means are unexpectedly shifted to an input bypassing an external connection device and the operability of the computer becomes worse.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary illustration of an information processing apparatus according to an embodiment of the present invention and a docking station which is an external device capable of making a wireless connection with the information processing apparatus according to a embodiment of the invention;

FIG. 2 is an exemplary block diagram showing a configuration of main components of the information processing apparatus according to the embodiment;

FIG. 3 is an exemplary flowchart showing a wireless connection process considered as a control method to which the information processing apparatus of the present invention is applied according to the embodiment;

FIG. 4 is an exemplary illustration of a display on an LCD indicating that an expansion device capable of wireless connection has been detected by a peripheral device of a computer according to the embodiment; and

FIG. 5 is an exemplary flowchart of processing of making a wireless connection between a computer and an expansion device by a connection management application, establishing connection, and then cutting off the connection according to the embodiment.

### DETAILED DESCRIPTION

Various embodiments according to the invention will be described hereinafter with reference to the accompanying drawings. In general, according to one embodiment of the invention, an information processing apparatus, comprises: a detector which detects an external device capable of making connection via wireless communication; a display unit which displays a screen urging a user to select whether or not the connection with the external device via the wireless communication should be made if the external device capable of making connection via wireless communication is detected by the detector; and a connector which makes the connection with external device via the wireless communication if a request for connection with the external device via the wireless communication is made after the screen is displayed on the display unit.

An embodiment of the present invention will be described below with reference to the accompanying drawings.

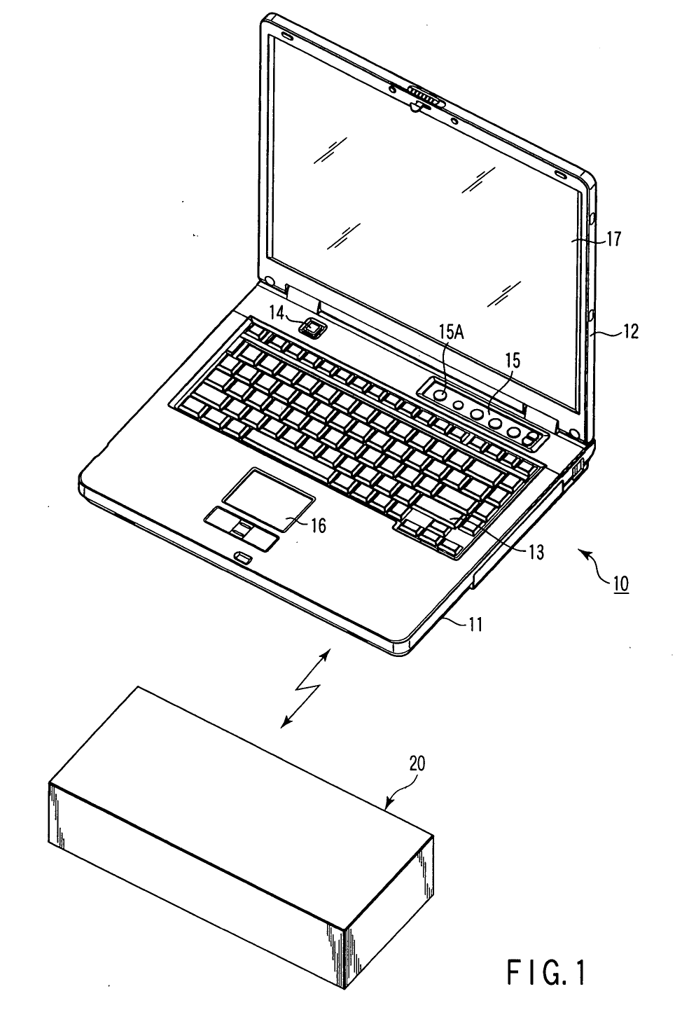

FIG. 1 is an illustration of an information processing apparatus according to an embodiment of the present invention and a docking station which is an external (connection) device capable of making a wireless connection with the information processing apparatus. The information processing apparatus is implemented as a notebook-type personal computer 10, which is battery-operated.

The computer 10 is composed of a main body 11 and a display unit 12. A display device composed of an LCD (Liquid Crystal Display) 17 is embedded in the display unit 12. A display screen of the LCD 17 is located approximately at the center of the display unit 12.

The display unit 12 is attached to the main body 11 so as to freely pivot between an opened position and a closed position. The main body 11 has a housing shaped in a thin box, and comprises a keyboard 13, a power button 14 for power-on/off of the computer 10, an input operation panel 15, and a touch pad 16, etc. on a top face thereof.

The input operation panel 15 is an input device for inputting an event corresponding to a pushed button in the system, and comprises a plurality of buttons for activating a plurality of functions. The button group includes a wireless connection button 15A, etc. The wireless connection button 15A is a button for permitting or cutting off a wireless connection with an external device (for example, an expansion device such as a docking station). When the button is pushed down by the user, the wireless connection with the external device is made. If the button is pushed down by the user under a condition that wireless connection with the external device is made, the wireless connection is cut off. The same operation may be implemented by pushing down a predetermined key (or a plurality of predetermined keys) on the keyboard 13 instead of the wireless connection button 15A.

A printer, an external keyboard, a mouse, an external storage device, etc. are connected to a docking station 20. These devices send or receive signals and data to/from the computer 10 via the docking station 20.

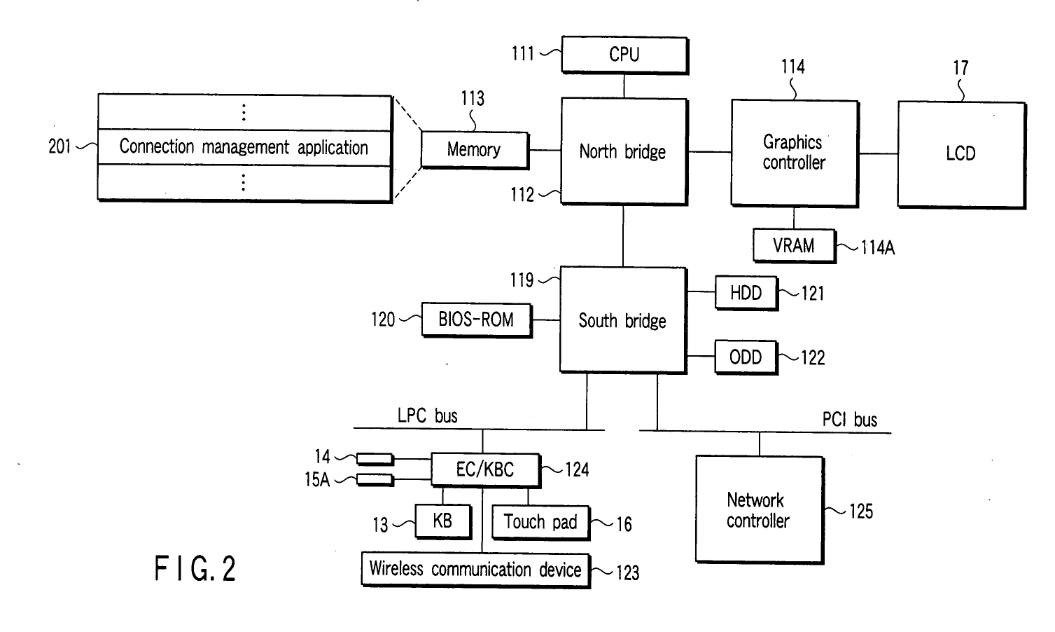

FIG. 2 is a block diagram showing a configuration of main components of the information processing apparatus according to the embodiment of the present invention.

The computer 10, as shown in FIG. 2, comprises a CPU 111, a north bridge 112, a main memory 113, a graphics controller 114, a south bridge 119, a BIOS-ROM 120, a hard disk drive (HDD) 121, an optical disk drive (ODD) 122, an embedded controller/keyboard controller IC (EC/KBC) 124, a wireless communication device 123, a network controller 125, etc.

The CPU 111 is a processor provided to control the operations of the computer 10, and executes the operating system (OS) and various kinds of application programs such as a connection management application 201 loaded on the main memory 113 by the hard disk drive (HDD) 121.

The connection management application 201 is software which controls establishment and cutoff of wireless connection of a detected external device. The connection management application 201 is controlled by the CPU 111.

The connection management application 201 monitors whether or not an external device capable of wireless connection exists around the computer 10, via the wireless communication device 123. If the connection management application 201 detects an external device capable of wireless connection around the computer 10, the connection management application 201 forms a predetermined display on the LCD 17, and establishes wireless connection between the computer 10 and the external device 20 by pushing down a displayed connection button (soft button), the wireless connection button 15A, and a predetermined key (or a plurality of predetermined keys) on the keyboard 13. In addition, the wireless connection between the computer 10 and the external device 20 is cut off by pushing down the wireless connection button 15A or a predetermined key (or a plurality of predetermined keys) on the keyboard 13.

In addition, the CPU 111 also executes the system BIOS (Basic Input Output System) stored in the BIOS-ROM 120. The system BIOS is a program which controls the hardware.

The north bridge 112 is a bridge device which makes connection between a local bus of the CPU 111 and the south bridge 119. A memory controller configured to control access to the main memory 113 is built in the north bridge 112. The north bridge 112 also has a function of executing communication with the graphics controller 114 via an AGP (Accelerated Graphics Port) bus.

The graphics controller 114 is a display controller which controls the LCD 17 employed as a display monitor of the computer 10. The graphics controller 114 generates a display signal which should be transmitted to the LCD 17 from image data written in a video memory (VRAM) 114A.

The south bridge 119 controls each device in an LPC (Low Pin Count) bus and each device in a PCI (Peripheral Component Interconnect) bus. An IDE (Integrated Drive Electronics) controller configured to control the HDD 121 and the ODD 122 is built in the south bridge 119. Moreover, the south bridge 119 has a function of controlling access to the BIOS-ROM 120.

The HDD 121 is a storage device which stores various kinds of software and data. The optical disk drive (ODD) 122 is a drive unit configured to drive storage media such as DVD storing video contents, etc.

The embedded controller/keyboard controller IC (EC/KBC) 124 is a one-chip microcomputer in which an embedded controller for power management and a keyboard controller configured to control the keyboard (KB) 13 and the touch pad 16 are integrated. The embedded controller/keyboard controller IC (EC/KBC) 124 has a function of controlling power-on/power-off of the computer 10, in response to the user's operation of the power button 14. Moreover, the embedded controller/keyboard controller IC (EC/KBC) 124 can also power on the computer 10 in response to the user's operation of the power button 14. The network controller 125 is a communication device configured to execute communications with an external network such as the Internet.

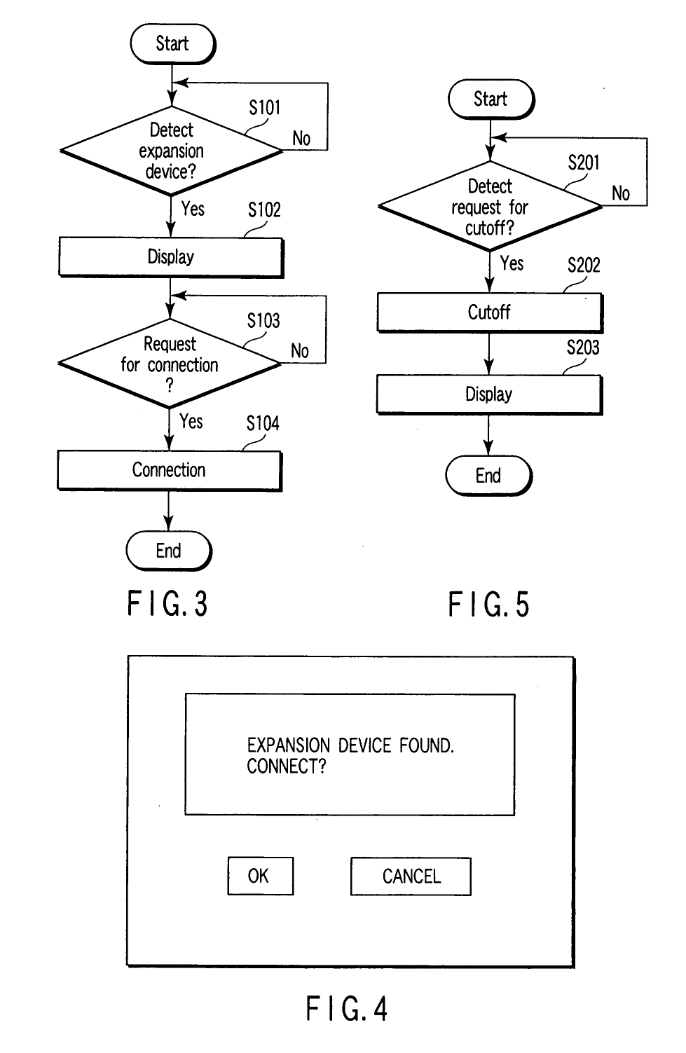

Next, a wireless connection process of the control method to which the information processing apparatus of the present invention is applied is described with reference to a flowchart of FIG. 3. FIG. 3 is a flowchart of the process. The external device 20 is described as an expansion device such as a docking station.

The connection management application 201 controlled by the CPU 111 of the controller 10 always monitors whether or not an expansion device (external device) such as a docking station capable of wireless connection exists around the computer 10. If the connection management application 201 detects an expansion device capable of wireless connection exists around the computer 10 (YES in step S101), the connection management application 201 displays the detection of the expansion device capable of wireless connection exists around the computer 10, on the LCD 17. A message of the screen display is, for example, “EXPANSION DEVICE FOUND. CONNECT?” as shown in FIG. 4, which urges the user to select whether or not the computer 10 should be connected to the external device, by wireless communication. In addition, for example, “OK” and “CANCEL” are displayed on the LCD 17 as soft buttons (step S102).

Next, after the above screen is displayed, the connection management application 201 detects presence or absence of a request for connection with the expansion device by wireless communication (step S103). If the connection management application 201 detects the request for connection with the expansion device (YES in step S103), the connection management application 201 processes the wireless connection between the computer 10 and the expansion device and establishes the connection (step S104).

The above “request for connection” may be made in the following cases where: for example, “OK” indicating the request for connection is selected by the soft button displayed on the screen, the wireless connection button 15A is pushed down, and a predetermined key or a plurality of predetermined keys on the keyboard 13 are pushed down.

Next, a process of processing the wireless connection between the computer and the expansion device by the connection management application 201, establishing the connection and then cutting off the connection is described with reference to FIG. 5. FIG. 5 is a flowchart of the cutting off the connection.

When the connection management application 201 detects a request for disconnection (YES in step S201), the connection management application 201 processes cutting off the wireless connection between the computer and the expansion device (step S202). When the connection management application 201 has processed cutting off the wireless connection between the computer and the expansion device, the connection management application 201 makes on the LCD 17 a display indicating that cutting off the wireless connection between the computer and the expansion device is completed (step S203).

The request for disconnection detected by the connection management application 201 may be made in the following cases where: for example, the wireless connection button 15A is pushed down in a state in which the wireless connection between the computer and the expansion device is established, and a predetermined key or a plurality of predetermined keys on the keyboard 13 are pushed down in a state in which the wireless connection between the computer and the expansion device is established.

According to the above embodiment of the present invention, in a case where the computer detects the external device such as a docking station which makes wireless connection, the connection is made under a desired condition and an unexpected connection can be prevented.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a detector which detects an external device capable of making connection via wireless communication;
a display unit which displays a screen urging a user to select whether or not the connection with the external device via the wireless communication should be made if the external device capable of making connection via wireless communication is detected by the detector; and
a connector which makes the connection with external device via the wireless communication if a request for connection with the external device via the wireless communication is made after the screen is displayed on the display unit.

2. The apparatus according to claim 1, wherein the connector makes the request for connection with the external device via a soft button displayed on the screen urging the user to select whether or not the connection with the external device via the wireless communication should be made.

3. The apparatus according to any one of claim 1 and 2, further comprising an input device, wherein the connector makes the request for connection with the external device via the input device after the screen urging the user to select whether or not the connection with the external device via the wireless communication should be made is displayed.

4. The apparatus according to claim 3, wherein if the connection with the external device via the wireless communication is made by the connector, a request for cutoff of the connection with the external device via the wireless communication is made via the input device.

5. A control method comprising:
detecting an external device capable of making connection via wireless communication;
displaying a screen urging a user to select whether or not the connection with the external device via the wireless communication should be made if the external device capable of making connection via wireless communication is detected; and
making the connection with external device via the wireless communication if a request for connection with the external device via the wireless communication is made after the screen is displayed.

6. The method according to claim 5, wherein it is input whether or not the connection with the external device, after the screen urging the user to select whether or not the connection with the external device via the wireless communication should be made is displayed, and the request for connection with the external device is made when the connection with the external device via the wireless communication is input.

7. The method according to claim 6, wherein if the connection with the external device via the wireless communication is made, when it is input that the connection with the external device via the wireless communication should be cut off, the connection via the wireless communication is cut off.
